(19) United States
(12) Patent Application Publication
(10) Pub. No.: US 2007/0094859 A1
(43) Pub. Date: May 3, 2007

(54) Manufacturing system

(75) Inventors: Gap-soo Lee, Suwon-si (KR); Joung-suu Lim, Suwon-si (KR); Kwan-hee Lee, Suwon-si (KR); Pan-su Kim, Suwon-si (KR); Young-mok Ju, Suwon-si (KR); Jeong-kyu Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/585,122

(22) Filed: Oct. 24, 2006

(30) Foreign Application Priority Data
Oct. 31, 2005 (KR) 2005-0102990

(51) Int. Cl. B23P 21/00

(52) U.S. Cl. 29/33 K; 29/705; 29/711; 29/729

(57) ABSTRACT

A manufacturing system comprising an assembly unit for assembling components of a product, a test unit for testing the assembled product and a packaging unit for packaging the product that has passed the test unit is provided. The assembly unit comprises a moving unit, a worktable adjacent to the moving unit, first and second auxiliary worktables and a caster provided on a lower portion thereof, and a rotator to rotate one of the first and second auxiliary worktables with respect to the other within an predetermined angle. The test unit comprises a rotation table, a base for supporting the rotation table, a driving unit provided on the base, and a plurality of jigs disposed on the rotation table at a predetermined interval. Thus, the manufacturing system provides improved productivity with a small work space and work force coping with an increase and decrease of production, and a variety of products.

### CROSS-REFERENCE TO RELATED APPLICATIONS

This application claims the benefit under 35 U.S.C. § 119(a) of Korean Patent Application No. 2005-0102990, filed on Oct. 31, 2005, in the Korean Intellectual Property Office, the entire disclosure of which is hereby incorporated by reference.

### BACKGROUND OF THE INVENTION

1. Field of the Invention

The present invention relates to a manufacturing system. More particularly, the present invention relates to a manufacturing system which comprises an assembly unit, a test unit and a packaging unit for products.

2. Description of the Related Art

Generally, products are manufactured through various processes before being supplied to a customer. A manufacturing system typically comprises a component manufacturing process, an assembly process which assembles components, a test process for an assembled product, and a packaging process in which the products are packaged.

Here, the product may comprise electronic appliances including a computer, a video or an audio player and machines.

Hereinafter, a monitor device manufacturing system as a type of display apparatus will be described as an example of the present invention.

Accordingly, as a life cycle of a monitor device becomes shorter, an existing manufacturing system which manufactures a small range of products in volume is replaced with a manufacturing system which manufactures various products in a small volume to satisfy various demands of customers. Also, a new manufacturing system which provides improved work efficiency with a small work force is required to properly cope with increase and decrease of production. Recently, customers tend to prefer a thin display panel such as a liquid crystal display (LCD) and a plasma display monitor (PDP) among various monitor devices.

The conventional monitor device manufacturing system comprises a straight-lined conveyor system. In the straight-lined conveyor system, a plurality of workers assembles respective components to a monitor device which is moved along the conveyor system that is arranged in a straight line. Generally, the conventional monitor device manufacturing system comprises a moving unit on which the monitor device is assembled and moved; and a vehicle and a component storage through which components to be assembled are moved and stored. The test process is provided to test the monitor device in various methods or adjust the monitor device to a predetermined state. While moving or stopping the monitor device on the conveyor line, the monitor device is tested to find malfunction during the test process. A pallet is generally used to support the monitor device in the test process. Then, the monitor device which has passed the test process is packaged.

In the conventional monitor device manufacturing system, the vehicle and the storage should be provided separately to assemble components on a worktable or a conveyor line. Accordingly, the length of an assembly unit becomes longer, thereby taking much space due to the keeping table and the worktable, and widening a working radius of a worker. Also, it is difficult to use the space efficiently. Further, since the conventional manufacturing system is arranged in a straight line or in a [symbol] -shaped line to perform various tests in the test process, the space efficiency becomes lowered and its configuration becomes complicated for power and signal supplying. Furthermore, the monitor device may be affected by vibrations, noises and shocks due to a long moving line.

Accordingly, there is a need for an improved manufacturing system for providing efficient space that is not affected by vibrations, noises and shocks.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide a manufacturing system which improves productivity with a small work space and work force coping with an increase and decrease of production, and a variety of products.

Also, it is another aspect of exemplary embodiments of the present invention to provide a manufacturing system in which a moving unit such as a conveyor is reduced, a pallet supporting a product is removed, which is less affected by vibrations or shocks caused when moving the product.

Additional aspects and/or advantages of exemplary embodiments of the present invention will be set forth in part in the description which follows and, in part, will be obvious from the description, or may be learned by practice of the present invention.

The foregoing and/or other aspects of exemplary embodiments of the present invention are also achieved by providing a manufacturing system comprising an assembly unit for assembling components of a product, a test unit for testing the assembled product and a packaging unit for packing the product that has passed the test unit. The assembly unit comprises a moving unit for moving the product, a worktable adjacent to the moving unit and on which the components of the product are assembled, first and second auxiliary worktables comprising a plurality of accommodators in which the components of the product are seated to be assembled to the product and a caster movably provided on a lower part thereof, and a rotator detachably provided to rotate at least one of the first and second auxiliary worktables corresponding to the other within a predetermined angle, the test unit comprising a rotation table which is shaped like a round plate for rotating, a base for supporting the rotation table, a driving unit provided on the base and supplies a driving force to rotate the rotation table, and a plurality of jigs disposed on the rotation table at a predetermined interval and support the product so that the rotation table rotates and forms a work station for a predetermined test.

In an exemplary implementation, the rotator comprises a plurality of projections which protrude from at least one of the first and second auxiliary worktables toward the other; and a plurality of projection accommodators provided on at least one of the first and second auxiliary worktables to be engaged with the projections.

In an exemplary implementation, the worktable and the first and second auxiliary worktables are disposed in a zigzag pattern, and the moving part is comprised therebetween.

In an exemplary implementation, the worktable comprises a rotating assembly table rotatably provided at a predetermined height and on which the components of the product are assembled.

In an exemplary implementation, the jigs comprise a fixing supporter which supports a first side of the product, a moving supporter which supports a second side of the product and moves in a lateral direction according to the size of the product, and an arm which is coupled with the rotation table and supports the fixing supporter and the moving supporter to rotate to a predetermined angle.

In an exemplary implementation, the arm comprises a speed controller for controlling the speed of the fixing supporter and the moving supporter.

In an exemplary implementation, the fixing supporter and the moving supporter each comprise an inclination member which is inclined to a predetermined angle, a bending member which is bent from a lower end of the inclination member, and a shock-absorbing member respectively attached to the inclination member and the bending member which provides contact with the product.

In an exemplary implementation, the shock-absorbing member comprises urethane.

In an exemplary implementation, the jigs comprise a pattern generator for supplying a predetermined signal to the product.

In an exemplary implementation, a signal is wirelessly transmitted in the pattern generator.

In an exemplary implementation, the manufacturing system further comprises a fixing table provided on a center area of the rotation table and coupled with the base, and a power supply electrically connected with the fixing table and the rotation table for supplying power or transmitting data therebetween.

In an exemplary implementation, the manufacturing system further comprises an operation table, provided below the rotation table, to be spaced therefrom and coupled with the base.

In an exemplary implementation, the manufacturing system further comprises a path which is detachably provided on a portion of the operation table for providing a user with access to a center area of the operation table.

In an exemplary implementation, the operation table comprises a medium density fiber board (MDF).

In an exemplary implementation, the manufacturing system further comprises an elastic radio frequency (RF) terminal brush provided on a portion of the rotation table to transmit a RF signal.

In an exemplary implementation, a control panel is provided at each work station to control the driving unit.

In an exemplary implementation, the assembly unit, the test unit and the packaging unit are sequentially arranged.

In an exemplary implementation, the product comprises a monitor or television device which ranges from 15 to 24 inches.

The foregoing and/or other aspects of exemplary embodiments of the present invention are also achieved by providing an assembly unit on which components of a product are assembled, comprising a moving unit for moving the product, a worktable adjacent to the moving unit and on which the components of the product are arranged, first and second auxiliary worktables comprising a plurality of accommodators in which the components of the product are seated to be assembled to the product and a caster movably provided on a lower portion thereof, and a rotator which is detachably provided to rotate at least one of the first and second auxiliary worktables corresponding to the other to a predetermined angle.

In an exemplary implementation, the rotator comprises a plurality of projections which protrude from at least one of the first and second auxiliary worktables toward the other, and a plurality of projection accommodators provided on at least one of the first and second auxiliary worktables to be engaged with the projections.

The foregoing and/or other aspects of exemplary embodiments of the present invention are also achieved by providing a test unit which tests and adjusts an assembled product, comprising a rotation table shaped like a round plate for rotating, a base for supporting the rotation table, a driving unit provided on the base and supplies a driving force to rotate the rotation table, and a plurality of jigs which is disposed on the rotation table at a predetermined interval and supports the product so that the rotation table rotates and forms a work station for a predetermined test.

In an exemplary implementation, the jigs comprise a fixing supporter for supporting a first side of the product, a moving supporter for supporting a second side of the product and moves in a lateral direction according to the size of the product, and an arm coupled with the rotation table and supports the fixing supporter and the moving supporter to rotate to a predetermined angle.

In an exemplary implementation, the arm comprises a speed controller for controlling the speed of the fixing supporter and the moving supporter.

In an exemplary implementation, the fixing supporter and the moving supporter each comprise an inclination member which is inclined to a predetermined angle, a bending member which is bent from a lower end of the inclination member, and a shock-absorbing member respectively attached to the inclination member and the bending member which provides contact with the product.

In an exemplary implementation, the jigs comprise a pattern generator for supplying a predetermined signal to the product.

In an exemplary implementation, the test unit further comprises a fixing table provided on a center area of the rotation table and coupled with the base, and a power supply which is electrically connected with the fixing table and the rotation table for supplying power or transmitting data therebetween.

In an exemplary implementation, the test unit further comprises an operation table provided below the rotation table to be spaced therefrom and coupled with the base.

In an exemplary implementation, the test unit further comprises an elastic radio frequency (RF) terminal brush provided on a portion of the rotation table for transmitting a RF signal.

In an exemplary implementation, a control panel is provided at each work station for controlling the driving unit.

In an exemplary implementation, the product comprises a monitor device which ranges from 15 to 21 inches.

### BRIEF DESCRIPTION OF THE DRAWINGS

The above and other objects, features and advantages of certain exemplary embodiments of the present invention will be more apparent from the following description taken in conjunction with the accompanying drawings, in which:

FIG. 1 is a plan view of a manufacturing system according to an exemplary embodiment of the present invention;

FIGS. 2A and 2B are a front view and a side view of first and second auxiliary worktables of the manufacturing system according to an exemplary embodiment of the present invention;

FIG. 3 is a perspective view of a test unit of the manufacturing system according to an exemplary embodiment of the present invention;

FIG. 4 is a sectional view of the test unit of the manufacturing system according to an exemplary embodiment of the present invention;

FIG. 5 is a perspective view of a jig of the manufacturing system according to an exemplary embodiment of the present invention;

FIGS. 6A and 6B illustrate a rotating state of the jig of the manufacturing system according to an exemplary embodiment of the present invention; and

FIG. 7 is a plot plan view of a workstation of the test unit of the manufacturing system according to an exemplary embodiment of the present invention.

Throughout the drawings, the same drawing reference numerals will be understood to refer to the same elements, features and structures.

### DETAILED DESCRIPTION OF EXEMPLARY EMBODIMENTS

The matters defined in the description such as a detailed construction and elements are provided to assist in a comprehensive understanding of exemplary embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

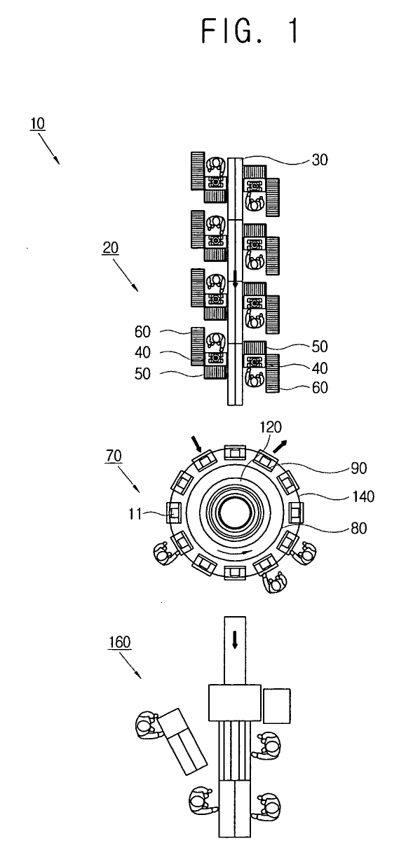

As shown in FIG. 1, a monitor device manufacturing system 10 according to an exemplary embodiment of the present invention comprises an assembly unit 20 which assembles components of a monitor device 11; a test unit 70 which tests and adjusts the assembled monitor device 11; and a packaging unit 160 which packages the monitor device 11 that has passed the test unit 70. The assembly unit 20, the test unit 70 and the packaging unit 160 of the monitor device manufacturing system 10 are sequentially disposed, thereby improving work efficiency. The respective units of the monitor device manufacturing system 10 may be variously disposed, for example, in series, in parallel or in radial arrangements necessary.

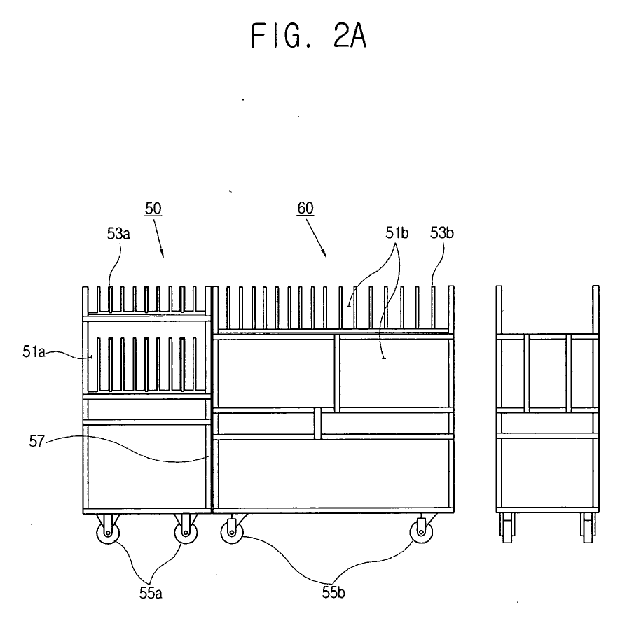

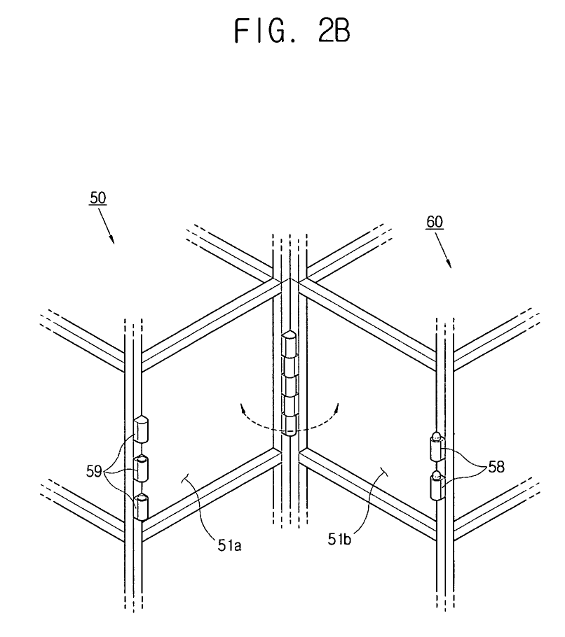

As shown in FIGS. 1, 2A and 2B, the assembly unit 20 comprises a moving unit 30 which moves the monitor device 11; a worktable 40 which is adjacent to the moving unit 30 to assemble components of the monitor device 11 thereon; a plurality of accommodators 51a and 51b in which the components of the monitor device 11 are seated to be assembled to the plurality of monitor devices 11; and a first auxiliary worktable 50 and a second auxiliary worktable 60 which have casters 55a and 55b movably provided on a lower part thereof. The first and second auxiliary worktables 50 and 60 comprise a rotator 57 which is detachably provided to rotate one of the first and second auxiliary worktables 50 and 60 with respect to the other within a predetermined angle.

As shown in FIG. 1, the moving unit 30 is provided on a center area of the assembly unit 20 to move the assembled monitor device 11. The moving unit 30 is generally provided as a conveyor. The moving unit 30 comprises a plurality of rollers (not shown) which are disposed in a row; and a driving motor (not shown) which provides a driving force to at least one of the plurality of rollers by a driving force transferring means such as a chain or a belt. The moving unit 30 may be provided as several conveyors, which are connectable to each other, are necessary.

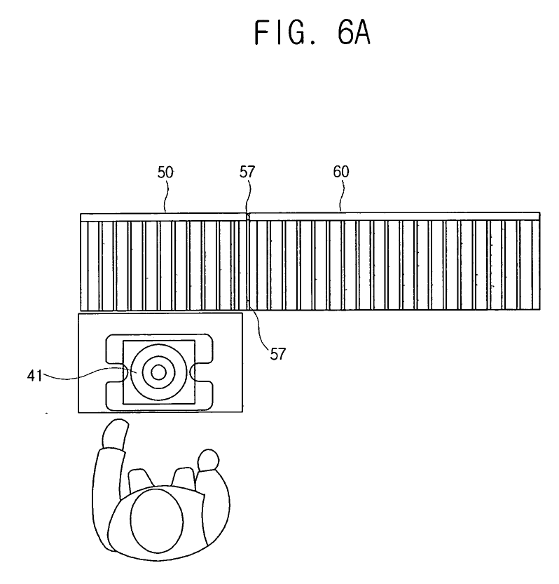

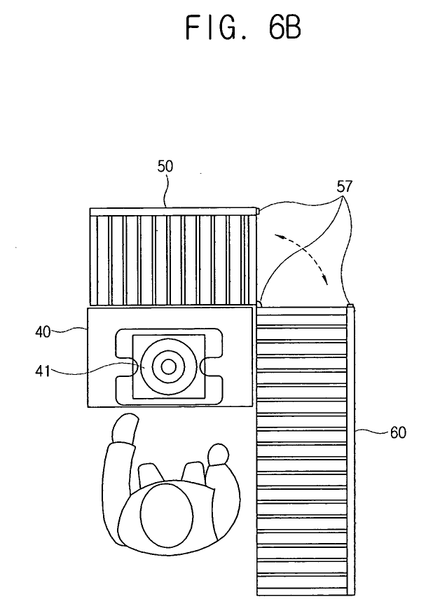

As shown in FIGS. 1, 2A and 2B, the worktable 40 is adjacent to the moving unit 30 to assemble the components of the monitor device 11 thereon. The worktable 40 has an open configuration so that a worker may move forwards and backwards, leftwards and rightwards when the worker assembles the components of the monitor device 11. Also, the respective worktables 40 face each other in a zigzag pattern, leaving the moving unit 30 therebetween, thereby reducing mutual interference while working. The worktable 40 comprises a rotating assembly table 41 (refer to FIGS. 6A and 6B) to support and assemble the components of the monitor device 11. The worktable 40 may further comprise an alarm lamp (not shown) which displays an operation state and an emergency; and an assembly work panel (not shown) which controls the alarm lamp.

As shown in FIGS. 1 and 2A, the first and second auxiliary worktables 50 and 60 comprise the plurality of accommodators 51a and 51b in which the components of the monitor device 11 are seated to assemble the plurality of monitor devices 11 thereon; casters 55a and 55b which are movably disposed on the lower part thereof; and the rotator 57 which is detachably provided to rotate one of the first and second auxiliary worktables 50 and 60 with respect to the other to a predetermined angle. The first and second auxiliary worktables 50 and 60 are adjacent to the worktable 40 and move the components into a predetermined place. One of the first and second auxiliary worktables 50 and 60 rotates to reduce a work radius of a worker, thereby performing functions as a component vehicle, a component storage and a work table.

As shown in FIGS. 2A and 2B, the accommodators 51a and 51b may accommodate the components to assemble the plurality of monitor devices 11 and comprise partitions 53a and 53b which are shaped like a bar to divide and accommodate the components as necessary. A shock absorber (not shown) is attached to a predetermined surface of the accommodators 51a and 51b, contacting with the components, thereby preventing damages of the components such as a scratch caused when moving, storing and withdrawing the components. For example, the accommodators 51a and 51b divide and accommodate a display unit (not shown) which displays an image thereon; a shield cover (not shown) which protects internal circuits; front and rear covers (not shown); and a cable (not shown) through which power and signals are supplied and transmitted. The shock absorber may be attached to a part of the accommodators 51a and 51b which accommodate the display unit.

As shown in FIG. 2A, the casters 55a and 55b are attached to a lower part of the first and second auxiliary worktables 50 and 60 to move the worktables 50 and 60. The casters 55a and 55b may comprise a brake to fix the worktables 50 and 60 as necessary.

As shown in FIGS. 2A and 2B, the rotator 57 comprises a plurality of projections 58 which protrudes from one of the first and second auxiliary worktables 50 and 60 toward the other; and a plurality of projection accommodators 59 which are provided on the other one of the first and second auxiliary worktables 50 and 60 to be engaged with the projections 58. The plurality of projections 58 are shaped like a ball and comprise a spring therein. Alternatively, the rotator 57 may comprise various configurations including a hinge and a hinge pin, a hook and a hook engaging unit.

Thus, the first and the second auxiliary worktables 50 and 60 perform functions as the component vehicle, the component storage and the work table, simultaneously, thereby reducing a required work space, using the work space efficiently, minimizing a moving operation of the conveyor and preventing noises and shocks when moving the monitor device 11. Further, the first and second auxiliary worktables 50 and 60 are adjacently disposed to the work radius of a worker, thereby reducing a required work force and providing improved productivity with a small work force.

As shown in FIGS. 1, 3 and 4, the test unit 70 comprises a rotation table 80 which is shaped like a round plate and rotates; a base 75 which supports the rotation table 80; a driving unit 81 which is provided on the base 75 to supply a driving force to the rotation table 80; and a plurality of jigs 90 which are disposed on the rotation table 80 at predetermined intervals and support the monitor device 11 so that the rotation table 80 rotates and forms a work station performing a predetermined test. The test unit 70 further comprises a pattern generator 110 which supplies a predetermined signal to the monitor device 11. The test unit 70 further comprises a fixing table 120 which is spaced from the rotation table 80 on the center thereof and coupled with the base 75; and an operation table 140 which is shaped like a plate and is spaced from the rotation table 80 on a lower part thereof and coupled with the base 75.

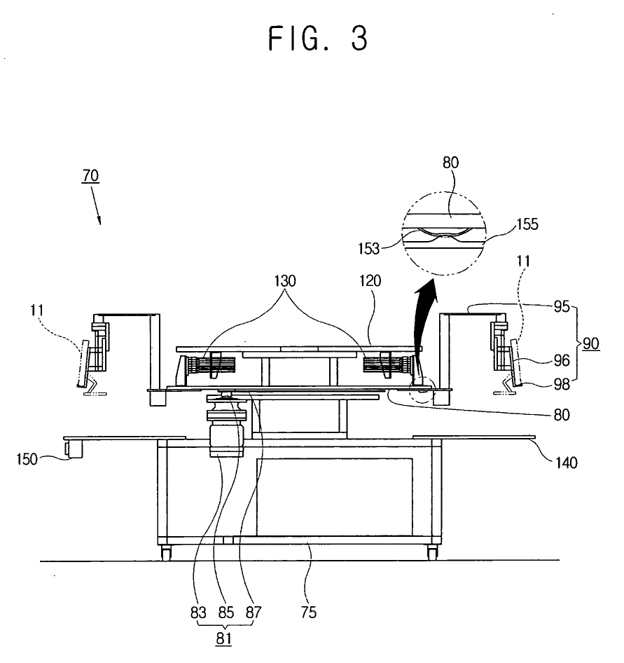

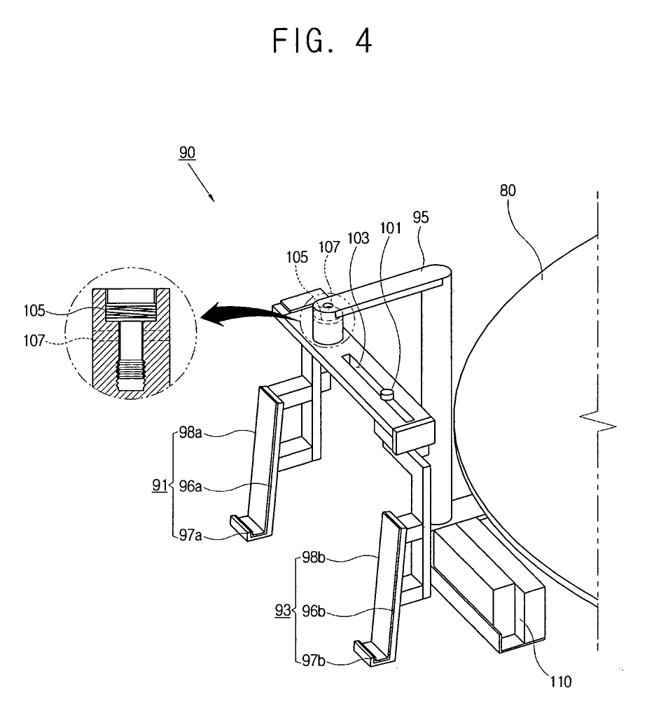

As shown in FIGS. 3 and 4, the rotation table 80 is shaped like a round plate and driven by the driving unit 81 to support the jigs 90. Thus, a conveyor and a pallet are not necessary to test the monitor device 11, thereby occupying a smaller space than the conventional conveyor and enhancing space efficiency. The rotation table 80 comprises a radio frequency (RF) terminal brush 153 which is provided on a lower part thereof to transmit a RF signal to the monitor device 11 supported by the jigs 90. As shown in FIG. 3, the RF terminal brush 153 comprises a flexible contacting surface which contacts with two copper plates 155 provided for ground and signals on the operation table 140 or the base 75 corresponding to the RF terminal brush 153. Thus, the monitor device 11 may receive the RF signal without interference by inductance. Here, the diameter of the rotation table 80 is approximately 1400 mm, when manufacturing the monitor device 11 ranging from 21 to 24 inches.

As shown in FIG. 3, the base 75 supports the rotation table 80 and is coupled with the driving unit 81, the operation table 140 and the fixing table 120. The base 75 may accommodate a power control box (not shown) and a PC (not shown) to perform the test.

As shown in FIG. 3, the driving unit 81 comprises a driving motor 83; a driving gear 85 which is connected with the driving motor 83; and a driven gear 87 which is engaged with the driving gear 85 and rotates the rotation table 80. As the rotation angle of the rotation table 80 is small, the driving motor 83 comprises a reduction gear. The driving motor is controlled to adjust the rotation speed and the rotation speed is reduced when almost reaching a predetermined rotation angle. Thus, the monitor device 11 is gradually moved, thereby preventing shocks and noises generated when moving the monitor device 11.

As shown in FIGS. 3 through 5, the jigs 90 are disposed on the rotation table 80 at predetermined intervals and support the monitor device 11 so that the rotation table 80 rotates and forms the work station to perform the predetermined test. The jigs 90 comprise a fixing supporter 91 which supports a first side of the monitor device 11; a moving supporter 93 which moves in a lateral direction according to the size of the monitor device 11 to support a second side of the monitor device 11; and an arm 95 which is coupled with the rotation table 80 and supports the fixing supporter 91 and the moving supporter 93 to rotate to a predetermined angle.

As shown in FIG. 4, the fixing supporter 91 supports the monitor device 11 together with the moving supporter 93. The fixing supporter 91 comprises inclination members 96 (96a and 96b) which are inclined to a predetermined angle to stably support the monitor device 11; and bending members 97a and 97b which are bent from a lower end of the inclination members 96a and 96b. Shock-absorbing members 98 (98a and 98b) are attached to the inclination members 96a and 96b and the bending members 97a and 97b which contact with the monitor device 11. The inclination members 96a and 96b and the bending members 97a and 97b are shaped like an elongated bar, but not limited thereto. Alternatively, the inclination members 96a and 96b and the bending members 97a and 97b may have various known shapes.

As shown in FIG. 4, the moving supporter 93 supports the monitor device 11 together with the fixing supporter 91. The moving supporter 93 has a structure that is capable of sliding laterally according to the size of the monitor device 11. The moving supporter 93 comprises the inclination members 96a and 96b, the bending members 97a and 97b and the shock-absorbing members 98a and 98b. Detailed description thereof will not be provided here as it has been described above or will be described later. The slidable structure of the moving supporter 93 comprises a sliding projection 101 which protrudes to an upper part of the inclination members 96a and 96b; and a sliding slot 103 which accommodates the sliding projection 101 and guides the moving supporter 93. Alternatively, the slidable structure may comprise other known means such as a roller.

Thus, the jigs 90 are adjusted without difficulty coping with the monitor devices 11 in various sizes, and the monitor device 11 is stably supported by the inclination members 96a and 96b, thereby effectively corresponding to unbalance due to rotation of the rotation table 80.

As shown in FIG. 4, the arm 95 is coupled with the rotation table 80 and rotatably supports the fixing supporter 91 and the moving supporter 93. The arm 95 comprises a speed controller 105 which controls a rotation speed of the fixing supporter 91 and the moving supporter 93; and an angle limiter 107 which limits the rotation of the fixing supporter 91 and the moving supporter 93 within a predetermined angle range.

As shown in FIG. 4, the speed controller 105 controls the rotation speed of the fixing supporter 91 and the moving supporter 93 which support the monitor device 11. The speed controller 105 may comprise an elastic member (not shown) such as a compression spring or a plate spring which is inserted into a rotation part thereof; and a screw (not shown) which controls a friction force of the elastic member. The speed controller 105 may further comprise various known elements. Thus, a worker rotates the monitor device 11 without difficulty, thereby improving work efficiency.

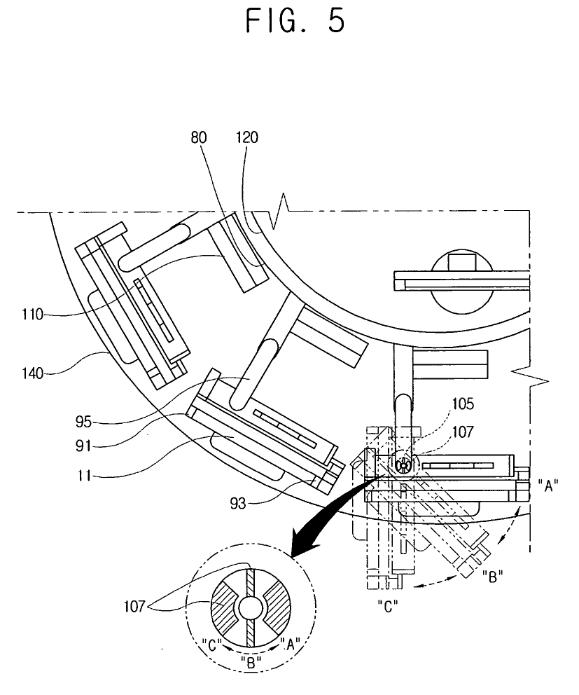

As shown in FIGS. 4 and 5, the angle limiter 107 is disposed on the arm 95 to make jigs 90 supporting the monitor device 11 rotate within the predetermined angle ranges. The angle limiter 107 may have various known structures. For example, the angle limiter 107 may comprise an angle limiting projection; and an angle limiting projection accommodator which is engaged with the angle limiting projection to guide the fixing supporter 91 and the moving supporter 91 to rotate.

As shown in FIG. 4, the shock-absorbing members 98a and 98b are attached to the inclination members 96a and 96b, and the bending members 97a and 97b which are contacted with the monitor device 11. The shock-absorbing members 98a and 98b comprise urethane which is highly durable and absorbs shock effectively, but not limited thereto. Alternatively, the shock-absorbing members 98a and 98b may comprise various known materials.

Thus, the monitor device 11 supported by the jigs 90 is prevented from damages such as a scratch.

As shown in FIG. 3, the pattern generator 110 supplies a predetermined signal to the monitor device 11. The pattern generator 110 is additionally provided with a power supply and is disposed on the jigs 90, respectively. Thus, the pattern generator 110 is connected with the monitor device 11 and displays an image on the display unit during test. In the pattern generator 110, a signal may be transmitted by infra data.

The test unit 70 has a round shape and comprises the jigs 90 supporting the monitor device 11, thereby occupying a smaller space than the elongated conveyor, using the space efficiently and reducing vibrations, shocks and noises generated when moving the monitor device 11 with a small rotation angle. Also, the working radius of a worker is reduced and the monitor device 11 is adjusted to a predetermined angle without difficulty, thereby providing improved productivity with a small work force. Further, as the monitor device 11 is supported by the jigs 90, the conventional pallet which supports the monitor device 11 is not necessary.

As shown in FIG. 3, the fixing table 120 is disposed on the rotation table 80 and coupled with the base 75 to fix a measuring instrument, which is required for a test at each work station. As the monitor device 11 supported by the fixing table 120, the operation table 140 and the jigs 90 is properly placed, a worker can perform various tests simultaneously. Here, the diameter of the fixing table 120 is approximately 1300 mm and the height thereof is about 1400 mm from a bottom, when manufacturing the monitor device 11 ranging from 21 to 24 inches.

As shown in FIG. 3, the power supply 130 is electrically connected with the fixing table 120 and the rotation table 80 to supply power and to transmit data. Preferably, the power supply 130 comprises a cover (not shown) to prevent damages due to an external contact.

As shown in FIG. 3, the operation table 140 is shaped like a plate and disposed below the rotation table 80 to be spaced therefrom and coupled with the base 75. The operation table 140 can be used as a working space. A control panel 150, which will be described later, is fixed to the operation table 140. Here, the diameter of the operation table 140 is about 2600 mm and the height thereof is about 800 mm, when manufacturing the monitor device 11 ranging from 21 to 24 inches. Thus, the test unit 70 occupies a smaller space than the conventional conveyor, thereby using the space efficiently, reducing the working radius of a worker, and providing improved work efficiency with a minimized work force.

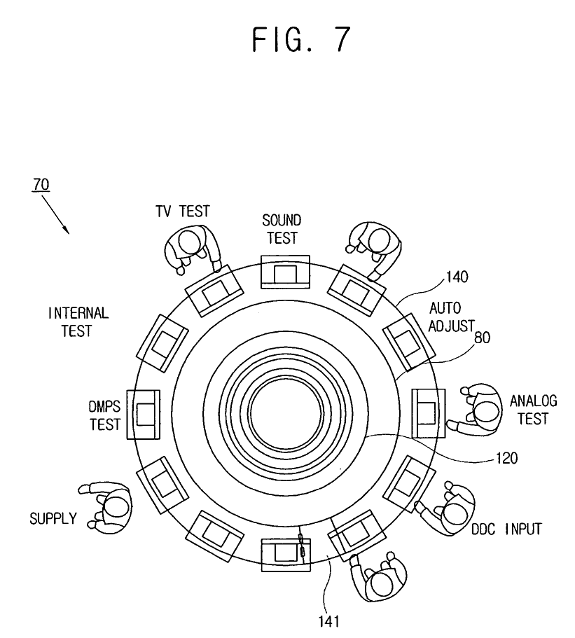

As shown in FIG. 7, a path 141 is detachably disposed on a part of the operation table 140 so that a worker can access a center area of the operation table 140. A worker may access the driving unit 81 of the rotation table 80 without difficulty, when repairing or replacing the driving unit.

The fixing table 120 and the operation table 140 comprises a medium density fiber board (MDF) which is light, fine in surface and strong, but not limited thereto. Alternatively, the fixing table 120 and the operation table 140 may comprise various known materials.

The path 141 may comprise a tower lamp (not shown) which displays an operation state of the system by color.

As shown in FIG. 3, the control panel 150 is disposed at each work station of the operation table 140 so that a worker may input a command such as work completion and emergency stop of the work station.

As shown in FIG. 1, the packaging unit 160 packages the monitor device 11 which has passed through the test unit 70. In the packaging unit 160, the monitor device 11 is packaged by a packaging box (not shown) which is provided to package the monitor device 11 in predetermined numbers and a shock absorber which protects the monitor device 11 from external shocks.

The monitor device 11 is provided as an example of the present invention, but not limited thereto. Alternatively, an exemplary embodiment of the present invention may be applicable for any various products that are assembled, tested, adjusted and packaged through a series of processes. Also, the rotation table, the work table may vary in size according to the size of products.

The manufacturing system 10 which manufactures the monitor device 11 may be provided in series or parallel as necessary.

With this configuration, a process of operating the manufacturing system 10 of the monitor device 11 according to an exemplary embodiment of the present invention will be described with reference to FIGS. 5 through 7.

First, components to be assembled as a plurality of monitor devices 11 are stably seated on the accommodators 51a and 51b of the first and second auxiliary worktables 50 and 60. As shown in FIG. 6A, the first and second auxiliary worktables 50 and 60 are moved to be adjacent to each worktable 40. The first auxiliary worktable 50 is provided in front of the second auxiliary worktable 60. As shown in FIG. 6B, the second auxiliary worktable 60 rotates 90° by the rotator 57 to be placed to a side part of the worktable 40 and adjacent to the working radius of a worker. At this time, the casters 55a and 55b are fixed. A worker assembles the components according to a predetermined assembly order to complete the monitor device 11. The completed monitor device 11 is moved to the assembly unit 20 by the moving unit 30 for a next process. When the plurality of components accommodated in the accommodators 51a and 51b of the first and second auxiliary worktables 50 and 60 are all used, the first and second auxiliary worktables 50 and 60 are coupled with each other in a straight line to be moved from the worktable 40 and to be replaced with another first and second auxiliary worktables 50 and 60 in which necessary components are stably seated. Thus, a worker may work without difficulty as his/her working radius is reduced. Also, a component keeping space is less required as additional storage is unnecessary. The length of the moving unit 30 is reduced, thereby reducing vibrations transferred to the monitor device 11, shocks and noises generated when moving the monitor device 11. Accordingly, work efficiency can be improved.

Hereinafter, it is assumed that the test unit 70 is divided into twelve (12) parts. In the test unit 70, there are provided twelve (12) jigs and twelve (12) work stations to perform the test. The size of the monitor device 11 may range from twenty-one (21) to twenty-four (24) inches. Additionally, the present invention may comprise more than twenty-four (24) inch monitor device.

The monitor device 11 which is assembled completely is moved to the test unit 70. The moving supporter 93 of the test unit 70 is adjusted in advance according to the size of the monitor device 11. The monitor device 11 is stably seated on the jigs 90 of the test unit 70 automatically or manually to be contacted with the shock-absorbing members 98a and 98b. The monitor device 11 may be stably seated on the jigs 90 through an automatic method by vacuum pressure as necessary. Power and signal connectors (not shown) which are adjacent to the jigs 90 are connected with power and signal cables of the monitor device 11. When power is supplied to the driving unit 81 of the test unit 70, the driving motor 83 of the driving unit 81 rotates the driving gear 85. When the driven gear 87 is driven by the driving gear 85, the rotation table 80 coupled with the driven gear 87 rotates to a predetermined angle. Here, a power supply 130 supplies power and transmits data. The RF terminal brush 153 may be connected with a concerned copperplate to transmit the RF signal.

As shown in FIG. 7, the monitor device 11 supported by the jigs 90 rotates and passes the tests sequentially. That is, the monitor device 11 passes a display power management signaling (DPMS) test which estimates power consumption of the monitor device 11 when receiving no signal; a voltage endurance test which tests whether the monitor device 11 endures a predetermined voltage; a digital test which tests a digital visual interface (DVI) terminal; an auto adjustment test which adjusts the size of an image according to the size of the display unit displaying an image thereon; an analog test which tests an analog signal; and a direct digital control (DDC) input test which supplies predetermined information to an erasable programmable read-only memory (EPROM).

As shown in FIG. 5, as the jig 90 rotates and the angle and speed of the jigs 90 are adjusted by the angle limiter 107 and the speed controller 105, a worker can work without difficulty.

Hereinafter, the respective tests which are implemented by automatic, semi-automatic and manual operations will be described.

First, the rotation table 80 rotates according to a predetermined input time in an automatic operation. When the predetermined time has passed, the driving unit 81 automatically rotates at a predetermined speed to rotate the rotation table 80 to 30°. Here, the driving unit 81 stops its operating. Here, the moving speed may be controlled in stages to not transfer shocks to the monitor device 11 supported by the jigs 90 or to not generate vibrations. A sensor (not shown) may be attached to the fixing table 120 to detect whether the rotation table 80 rotates 30° exactly. The rotation table 80 may be interlocked not to rotate itself, when the predetermined tests (for example, the voltage endurance test and the DMPS test) are not completed. A worker may be informed of the rotation of the rotation table 80 seconds before the rotation thereof in the automatic operation.

In the semi-automatic operation, a worker inputs a completion signal through the control panel 150 when the predetermined test is completed. When all the workers input the completion signal, the driving unit 81 automatically operates to rotate the rotation table 80 to 30°. Here, the driving unit 81 stops operating.

In the manual operation, a worker who is responsible for the final work confirms whether the work is completed and controls the control panel 150 to rotate the rotation table 80. Also, a worker may raise an alarm for emergency.

The monitor device 11 which has passed the predetermined tests at the respective work stations is withdrawn from the jigs 90 and moved to the packaging unit 160. The withdrawal process and the seat process of the monitor device 11 may be completed by the vacuum pressure. The monitor device 11 is packaged by the packaging box provided to package the monitor device 11 in predetermined numbers and a shock absorber which protects the monitor device from external shocks.

As described above, the assembly unit according to exemplary embodiments of the present invention comprises a minimized conveyor, and the test unit does not have the conveyor, thereby drastically reducing the pallet. As a round-shaped work station is provided in the test unit, the test unit occupies less and enhances the space efficiency. As the monitor device is slowly moved in the test unit, the monitor device may be prevented from shocks, vibrations and external forces due to the fast moving speed. Further, a worker can work without difficulty as the monitor device rotates by the jigs, thereby reducing the working radius of a worker and improving work efficiency. Accordingly, work efficiency can be improved through a minimized work force. Thus, the manufacturing system according to exemplary embodiments of the present invention may cope with various products and with the increase/decrease of production.

Exemplary embodiments of the present invention also provides a manufacturing system, which reduces a moving unit, such as a conventional conveyor, and a pallet supporting products, and prevents vibrations, shocks and noises generated when the conveyor moves fast.

While the invention has been shown and described with reference to certain exemplary embodiments thereof, it will be understood by those skilled in the art that various changes in form and details may be made therein without departing from the spirit and scope of the invention as defined in the appended claims and their equivalents.

What is claimed is:

1. A manufacturing system comprising:
an assembly unit for assembling components of a product;
a test unit for testing the product; and
a packaging unit for packaging the product that passed the test unit,
the assembly unit comprising a moving unit for moving a product, a worktable adjacent to the moving unit on which the components of the product are assembled, first and second auxiliary worktables comprising a plurality of accommodators in which the components of the product are seated to be assembled to the product and a caster movably provided on a lower portion of the first and second auxiliary worktables, and a rotator detachably provided for rotating at least one of the first and second auxiliary worktables corresponding to the other within a reference angle, and
the test unit comprising a rotation table shaped like a round plate for rotating, a base for supporting the rotation table, a driving unit provided on the base for supplying a driving force for rotating the rotation table, and a plurality of jigs, disposed on the rotation table at a reference interval, for supporting the product so that the rotation table rotates and forms a work station for a test.

2. The manufacturing system according to claim 1, wherein the rotator comprises:
a plurality of projections protruding from at least one of the first and second auxiliary worktables toward each other; and
a plurality of projection accommodators provided on at least one of the first and second auxiliary worktables for engaging with the projections.

3. The manufacturing system according to claim 1, wherein the worktable and the first and second auxiliary worktables are disposed in a zigzag pattern and the moving unit is comprised between the worktable and the first and second auxiliary worktables.

4. The manufacturing system according to claim 1, wherein the worktable comprises a rotating assembly table rotatably provided at a reference height and on which the components of the product are assembled.

5. The manufacturing system according to claim 1, wherein the jigs comprise:
a fixing supporter for supporting a first side of the product;
a moving supporter for supporting a second side of the product and moves in a lateral direction according to the size of the product; and
an arm coupled with the rotation table for supporting the fixing supporter and the moving supporter to rotate to an angle.

6. The manufacturing system according to claim 5, wherein the arm comprises a speed controller for controlling the speed of the fixing supporter and the moving supporter.

7. The manufacturing system according to claim 5, wherein the fixing supporter and the moving supporter comprise:
an inclination member inclined to an angle;
a bending member bent from a lower end of the inclination member; and
a shock-absorbing member respectively attached to the inclination member and the bending member for providing contact with the product.

8. The manufacturing system according to claim 7, wherein the shock-absorbing member comprises urethane.

9. The manufacturing system according to claim 1, wherein the jigs comprise a pattern generator for supplying a signal to the product.

10. The manufacturing system according to claim 9, wherein the signal is wirelessly transmitted in the pattern generator.

11. The manufacturing system according to claim 1, wherein the test unit further comprises:
a fixing table provided on a center area of the rotation table and coupled with the base; and
a power supply electrically connected with the fixing table and the rotation table for at least one of supplying power and transmitting data between the fixing table and the rotation table.

12. The manufacturing system according to claim 1, wherein the test unit further comprises an operation table, provided below the rotation table, coupled with the base.

13. The manufacturing system according to claim 12, further comprising a path detachably provided on a portion of the operation table for providing a user with access to a center area of the operation table.

14. The manufacturing system according to claim 13, wherein the operation table comprises a medium density fiber board (MDF).

15. The manufacturing system according to claim 1, wherein the rotation table further comprising an elastic radio frequency (RF) terminal brush provided on a portion of the rotation table for transmitting a RF signal.

16. The manufacturing system according to claim 1, further comprising a control panel provided at the work station for controlling the driving unit.

17. The manufacturing system according to claim 1, wherein the assembly unit, the test unit and the packaging unit are sequentially arranged.

18. The manufacturing system according to claim 1, wherein the product comprises a monitor device or a television comprising a size ranging from 15 to 24 inches.

19. An assembly unit comprised in a manufacturing system on which components of a product are assembled, comprising:
a moving unit for moving a product;
a worktable adjacent to the moving unit on which the components of the product are arranged;
first and second auxiliary worktables comprising a plurality of accommodators in which the components of the product are seated to be assembled to the product and a caster which is movably provided on a lower portion of the first and second auxiliary worktables; and
a rotator detachably provided for rotating at least one of the first and second auxiliary worktables corresponding to the other to a reference angle.

20. The assembly unit according to claim 19, wherein the rotator comprises:
a plurality of projections protruding from at least one of the first and second auxiliary worktables toward each other; and
a plurality of projection accommodators provided on at least one of the first and second auxiliary worktables for engaging with the projections.

21. A test unit comprised in a manufacturing system for testing and adjusting an assembled product, comprising:
a rotation table shaped like a round plate for rotating;
a base for supporting the rotation table;
a driving unit provided on the base for supplying a driving force for rotating the rotation table; and
a plurality of jigs disposed on the rotation table at a reference interval for supporting the product so that the rotation table rotates and forms a work station for a test.

22. The test unit according to claim 21, wherein the jigs comprise:
a fixing supporter for supporting a first side of the product;
a moving supporter for supporting a second side of the product and moves in a lateral direction according to the size of the product; and
an arm coupled with the rotation table for supporting the fixing supporter and the moving supporter to rotate to a reference angle.

23. The test unit according to claim 22, wherein the arm comprises a speed controller for controlling the speed of the fixing supporter and the moving supporter.

24. The test unit according to claim 22, wherein the fixing supporter and the moving supporter comprise:
an inclination member inclined to an angle;
a bending member bent from a lower end of the inclination member; and
a shock-absorbing member respectively attached to the inclination member and the bending member for providing contact with the product.

25. The test unit according to claim 21, wherein the jigs comprise a pattern generator a signal to the product.

26. The test unit according to claim 21, further comprising:
a fixing table provided on a center area of the rotation table and coupled with the base; and
a power supply electrically connected with the fixing table and the rotation table for supplying power and transmitting data between the fixing table and the rotation table.

27. The test unit according to claim 21, further comprising an operation table, provided below the rotation table, coupled with the base.

28. The test unit according to claim 21, wherein the rotation table further comprises an elastic radio frequency (RF) terminal brush provided on a portion of the rotation table for transmitting a RF signal.

29. The test unit according to claim 21, further comprising a control panel provided at the work station for controlling the driving unit.

30. The test unit according to claim 21, wherein the product comprises a monitor device or a television comprising a size ranging from 15 to 24 inches.
